(19) United States
(12) Patent Application Publication
(10) Pub. No.: US 2015/0379446 A1
(43) Pub. Date: Dec. 31, 2015

(54) FORCE-BASED ASSIGNMENTS

(71) Applicant: International Business Machines Corporation, Armonk, NY (US)

(72) Inventors: Marcelo Blechner, Sao Paulo (BR); Cristiano M. Breuel, Sao Paulo (BR); Moreno S. Mello, Sao Paulo (BR); Tiago B. Scarton, Sao Paulo (BR)

(21) Appl. No.: 14/845,325

(22) Filed: Sep. 4, 2015

Related U.S. Application Data
(63) Continuation of application No. 14/108,457, filed on Dec. 17, 2013.

(51) Int. Cl. G06Q 10/06; G06Q 10/02

(52) U.S. Cl. CPC G06Q 10/06311; G06Q 10/02

(57) ABSTRACT

A method for assigning locations to persons of a group of persons may include determining, for each person in the group, a number of communications between the person and each other person in the group. A plurality of reservations from reserving persons of the group may be received. A first force-directed graph having a node for each reserving person may be generated. The generating of the graph may include establishing an edge between one or more pairs of reserving persons, and assigning a first weight to the one or more edges that is derived from the number of communications between respective pairs of reserving persons. Each reserving person may be assigned to a location in the area using the first force-directed graph. A resource for a location not assigned to a reserving person may be controlled based on the assigning of reserving persons to locations.

### BACKGROUND

The disclosure relates generally to force-based assignments, and more particularly, assigning locations to persons to using force-based techniques.

Many commercial, nonprofit, government, and other organizations have building space with seating locations or work spaces for persons. For example, an organization may have office space with many individual work spaces, such as desks or cubicles for the use of workers, volunteers, students, visitors, or others. The persons using the office space may not need a work location in the building every day because, on some days, they work at home, a customer's site, or other location. For this reason, these persons may not have a permanently assigned seating location in the building. Persons who do not require a permanently assigned seating location may use a seating location in a shared group of seating locations on occasions when they are present in the building.

### SUMMARY

An embodiment is directed to a computer-implemented method for assigning locations to persons of a group of persons. The method may include, for each person in the group, determining a number of communications between the person and each other person in the group. In addition, the method may include receiving a plurality of reservations from reserving persons of the group. Each reservation may request a placement of a reserving person in a location in an area having plural locations. A first force-directed graph having a node for each reserving person may be generated. The generating of the force-directed graph may include establishing an edge between one or more pairs of reserving persons. The generating of the force-directed graph may also include assigning a first weight to the one or more edges that is derived from the number of communications between respective pairs of reserving persons. Further, the method may include assigning each reserving person to a location in the area using the first force-directed graph. Moreover, the method may include controlling, based on the assigning of reserving persons to locations, a resource for a location not assigned a reserving person.

In various embodiments, the method determining that the number of communications between a first pair of reserving persons is zero, and assigning a second weight to an edge between the first pair of reserving persons.

In addition, in various embodiments, the method may include generating a second force-directed graph in response to receiving a user input to modify one of the first weights. Each reserving person may be assigned to a location in the area using the second force-directed graph.

Moreover, in various embodiments, the method may include, for each person, determining a number of times the person was within a particular range of an electronic reader. In these embodiments, the generating of the first force-directed graph may include providing a node for the electronic reader and establishing an edge between the electronic reader and a reserving person determined to be within the particular range of the electronic reader one or more times. In addition, the method may include assigning a second weight to the edge between the electronic reader and the reserving person that is proportional to the number of times the reserving person was within the particular range of the electronic reader.

Various other embodiments are directed to a system and computer program product for assigning locations to persons of a group of persons.

### BRIEF DESCRIPTION OF THE DRAWINGS

FIG. 1 is a block diagram of a system for assigning locations in an area according to various embodiments.

FIG. 2 is a block diagram of an exemplary computer system for implementing various embodiments of the assignment system of FIG. 1.

FIG. 3 is a flow diagram of a process for force-based assignment of locations in an area according to various embodiments.

FIG. 4 is a flow diagram of a process for receiving reservations for force-based assignments of locations according to various embodiments.

FIG. 5 is a flow diagram of a process for modifying force-based assignments of locations in an area according to various embodiments.

FIG. 6 is a flow diagram of a process for generating a graph according to various embodiments.

FIG. 7 shows one example of an area having locations according to various embodiments.

FIG. 8 illustrates an exemplary force-based graph generated according to various embodiments.

FIG. 9 shows the graph of FIG. 8 after it has been scaled and oriented according to various embodiments.

FIG. 10 shows nodes of the graph of FIG. 8 after the nodes have been mapped to particular locations of the area of FIG. 7 according to various embodiments.

FIG. 11 illustrates a graph after particular weights have been disregarded according to various embodiments.

FIG. 12 shows the graph of FIG. 11 after it has been scaled and oriented according to various embodiments.

FIG. 13 shows nodes of the graph of FIG. 11 after the nodes have been mapped to particular locations according to various embodiments.

FIG. 14 illustrates the graph of FIG. 11 after packing weights have been added according to various embodiments.

FIG. 15 shows the graph of FIG. 14 scaled and oriented to the area according to various embodiments.

FIG. 16 shows nodes of the graph of FIG. 14 after the nodes have been mapped to particular locations according to various embodiments.

Like reference numbers and designations in the various drawings indicate like elements. Dimensions of various aspects of the drawings, such as the length of edges between nodes, are intended to be representative and may not be to scale.

### DETAILED DESCRIPTION

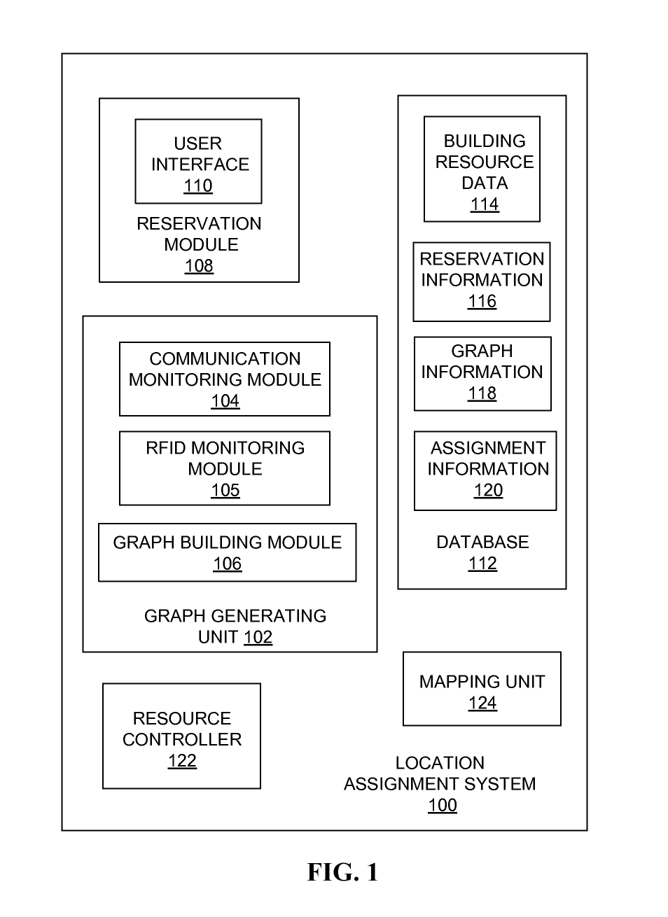

FIG. 1 is a block diagram of a system 100 for assigning locations in an area using force-based techniques according to various embodiments. The system 100 includes a graph generating unit 102 that generates a network between persons, e.g., employees, in a group. As described below, in the network, persons are assigned to nodes. Edges connect the nodes. The lengths of the edges are based on weights determined from inferences. The inferences may be based on electronic communications between persons, such as emails, instant messaging, and phone calls. The network may be similar to a social network, however, the electronic communications may be limited to communications that relate to the business of the organization and exclude non-business related communications. In addition, in some embodiments, the inferences may be based on location data for a person.

The graph generating unit 102 may include a communication monitoring module 104 that periodically monitors various electronic communications between persons in the group that occur within a particular period of time. The graph generating unit 102 may also include a location monitoring module 105 that receives data representative of a person's movement over a particular period of time. In addition, the graph generating unit 102 may include a graph building module 106 that generates a graph using various types of data, such as communication or location data. The graph building module 106 uses these inputs along with building resource data 114 to assign seating locations to workers at any suitable time, typically on a periodic basis, such as daily.

The assignment system 100 also includes a reservation module 108. The reservation module 108 includes a user interface 110 that allows persons to schedule the days and times that he or she intends to use an area, such as an office or other building. Persons may indicate their need for a seating location either on a day-by-day basis or on a regular schedule. The user interface 110 may be rendered as a mobile application (“app”) on a smart phone, a web page on personal computer, smart phone, tablet, or other device, or in any other form on any suitable device. Additionally, the user interface may be rendered on a computer system or other device at a self-service station in one or more areas of the building, e.g., near an entrance. The user interface 110 may be used by workers or other persons prior to or upon arrival at the building. The user interface 110 informs persons of their assigned seats. The seating locations may be shown on a floor plan.

The assignment system 100 may also include a database 112. The database 112 may store various types of information. The database 112 may store building resource data 114, such as maps or floor plans of rooms in one or more buildings (the “area”). Floor plans may indicate the locations of windows, doors, HVAC (heating, ventilation, and air conditioning) inlets and outlets, lighting, printers, electrical outlets, and voice and a data communication ports in the area, as well as seating locations. With respect to seating locations in the area, the database 112 may store the size and various features of individual seating locations, such as whether the work space includes a standing or sitting desk, the availability of electrical and network connectors, and the type of lighting.

The database 112 may store building reservation information 116. Information input into the reservation module 108 by a person may be stored in the reservation information 116. Information input into the reservation module 108 may include dates and times desired, and any user preferences. In addition, the database 112 may store graph information 118 defining a network graph and location assignment information 120.

The assignment system 100 may include a resource controller 122. The resource controller 122 receives location assignment information and controls resources of the building based on the assignment information. Exemplary resources include HVAC and lighting. As one example, resource controller 122 may turn off lighting in unassigned locations. Energy conservation may be an advantage of the embodiments described herein. The assignment system 100 may also include a mapping module 124 that may scale a graph to an area and orient a graph to an area. In addition, the mapping module 124 may map nodes of a graph to particular locations in an area.

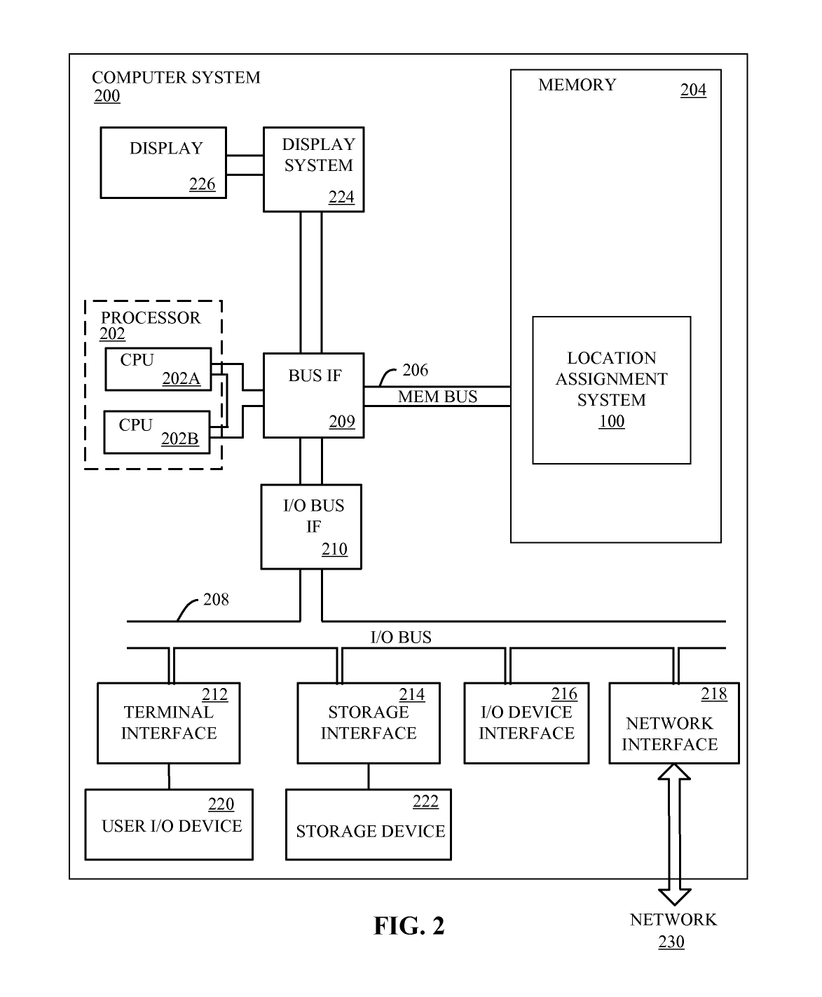

FIG. 2 depicts a high-level block diagram of an exemplary computer system 200 for implementing various embodiments of the assignment system 100. The mechanisms and apparatus of the various embodiments disclosed herein apply equally to any appropriate computing system. The major components of the computer system 200 include one or more processors 202, a memory 204, a terminal interface 212, a storage interface 214, an I/O (Input/Output) device interface 216, and a network interface 218, all of which are communicatively coupled, directly or indirectly, for inter-component communication via a memory bus 206, an I/O bus 208, bus interface unit 209, and an I/O bus interface unit 210.

The computer system 200 may contain one or more general-purpose programmable central processing units (CPUs) 202A and 202B, herein generically referred to as the processor 202. In an embodiment, the computer system 200 may contain multiple processors; however, in another embodiment, the computer system 200 may alternatively include a single CPU. Each processor 202 executes instructions stored in the memory 204 and may include one or more levels of on-board cache.

In an embodiment, the memory 204 may include a random-access semiconductor memory, storage device, or storage medium (either volatile or non-volatile) for storing or encoding data and programs. In another embodiment, the memory 204 represents the entire virtual memory of the computer system 200, and may also include the virtual memory of other computer systems coupled to the computer system 200 or connected via a network. The memory 204 is conceptually a single monolithic entity, but in other embodiments the memory 204 is a more complex arrangement, such as a hierarchy of caches and other memory devices. For example, memory may exist in multiple levels of caches, and these caches may be further divided by function, so that one cache holds instructions while another holds non-instruction data, which is used by the processor 202. Memory may be further distributed and associated with different CPUs or sets of CPUs, as is known in any of various so-called non-uniform memory access (NUMA) computer architectures.

The memory 204 may store all or a portion of the modules, units, and databases of the assignment system 100. These programs and data structures are illustrated as being included within the memory 204 in the computer system 200, however, in other embodiments, some or all of them may be on different computer systems and may be accessed remotely, e.g., via a network. The computer system 200 may use virtual addressing mechanisms that allow the programs of the computer system 200 to behave as if they only have access to a large, single storage entity instead of access to multiple, smaller storage entities. Thus, while the seating system 100 is illustrated as being included within the memory 204, the various components of assignment system 100 are not necessarily all completely contained in the same storage device at the same time. Further, although the modules, units, and databases of the assignment system 100 are illustrated as being separate entities in FIG. 1, in other embodiments some of them, portions of some of them, or all of them may be packaged together.

In an embodiment, the modules, units, and databases of the assignment system 100 may include instructions or statements that execute on the processor 202 or instructions or statements that are interpreted by instructions or statements that execute on the processor 202 to carry out the functions as further described below. In another embodiment, the modules, units, and databases of the assignment system 100 are implemented in hardware via semiconductor devices, chips, logical gates, circuits, circuit cards, and/or other physical hardware devices in lieu of, or in addition to, a processor-based system. In an embodiment, the modules, units, and databases of the assignment system 100 may include data in addition to instructions or statements.

The graph generating unit 102 may include various processes that generate one or more force-directed graphs according to various embodiments. In addition, the reservation module 108 may include various processes that generate reservation information 116 according to various embodiments. Moreover, the resource controller 122 may include various processes that control building resources according to various embodiments.

The computer system 200 may include a bus interface unit 209 to handle communications among the processor 202, the memory 204, a display system 224, and the I/O bus interface unit 210. The I/O bus interface unit 210 may be coupled with the I/O bus 208 for transferring data to and from the various I/O units. The I/O bus interface unit 210 communicates with multiple I/O interface units 212, 214, 216, and 218, which are also known as I/O processors (IOPs) or I/O adapters (IOAs), through the I/O bus 208. In addition, one or more of the functions provided by the bus interface unit 209 may be on board an integrated circuit that also includes the processor 202.

The display system 224 may include a display controller, a display memory, or both. The display controller may provide video, audio, or both types of data to a display device 226. The display memory may be a dedicated memory for buffering video data. The display system 224 may be coupled with a display device 226, such as a standalone display screen, computer monitor, television, or a tablet or handheld device display. In one embodiment, the display device 226 may include one or more speakers for rendering audio. Alternatively, one or more speakers for rendering audio may be coupled with an I/O interface unit. In alternate embodiments, one or more of the functions provided by the display system 224 may be on board an integrated circuit that also includes the processor 202. The display system 224 may be employed to display the user interface 100.

The I/O interface units support communication with a variety of storage and I/O devices. For example, the terminal interface unit 212 supports the attachment of one or more user I/O devices 220, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 220 and the computer system 200, and may receive output data via the user output devices. For example, the user interface 110 may be presented via the user I/O device 220, such as displayed on a display device, played via a speaker, or printed via a printer.

The storage interface 214 supports the attachment of one or more disk drives or direct access storage devices 222 (which are typically rotating magnetic disk drive storage devices, although they could alternatively be other storage devices, including arrays of disk drives configured to appear as a single large storage device to a host computer, or solid-state drives, such as flash memory). In another embodiment, the storage device 222 may be implemented via any type of secondary storage device. The contents of the memory 204, or any portion thereof, may be stored to and retrieved from the storage device 222 as needed. The I/O device interface 216 provides an interface to any of various other I/O devices or devices of other types, such as printers or fax machines. The network interface 218 provides one or more communication paths from the computer system 200 to other digital devices and computer systems; these communication paths may include, e.g., one or more networks 230.

Although the computer system 200 shown in FIG. 2 illustrates a particular bus structure providing a direct communication path among the processors 202, the memory 204, the bus interface 209, the display system 224, and the I/O bus interface unit 210, in alternative embodiments the computer system 200 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 210 and the I/O bus 208 are shown as single respective units, the computer system 200 may, in fact, contain multiple I/O bus interface units 210 and/or multiple I/O buses 208. While multiple I/O interface units are shown, which separate the I/O bus 208 from various communications paths running to the various I/O devices, in other embodiments, some or all of the I/O devices are connected directly to one or more system I/O buses.

In various embodiments, the computer system 200 is a multi-user mainframe computer system, a single-user system, or a server computer or similar device that has little or no direct user interface, but receives requests from other computer systems (clients). In other embodiments, the computer system 200 may be implemented as a desktop computer, portable computer, laptop or notebook computer, tablet computer, pocket computer, telephone, smart phone, or any other suitable type of electronic device.

FIG. 2 is intended to depict the representative major components of the computer system 200. Individual components, however, may have greater complexity than represented in FIG. 2, components other than or in addition to those shown in FIG. 2 may be present, and the number, type, and configuration of such components may vary. Several particular examples of additional complexity or additional variations are disclosed herein; these are by way of example only and are not necessarily the only such variations. The various program components illustrated in FIG. 2 may be implemented, in various embodiments, in a number of different manners, including using various computer applications, routines, components, programs, objects, modules, data structures, etc., which may be referred to herein as “software,” “computer programs,” or simply “programs.”

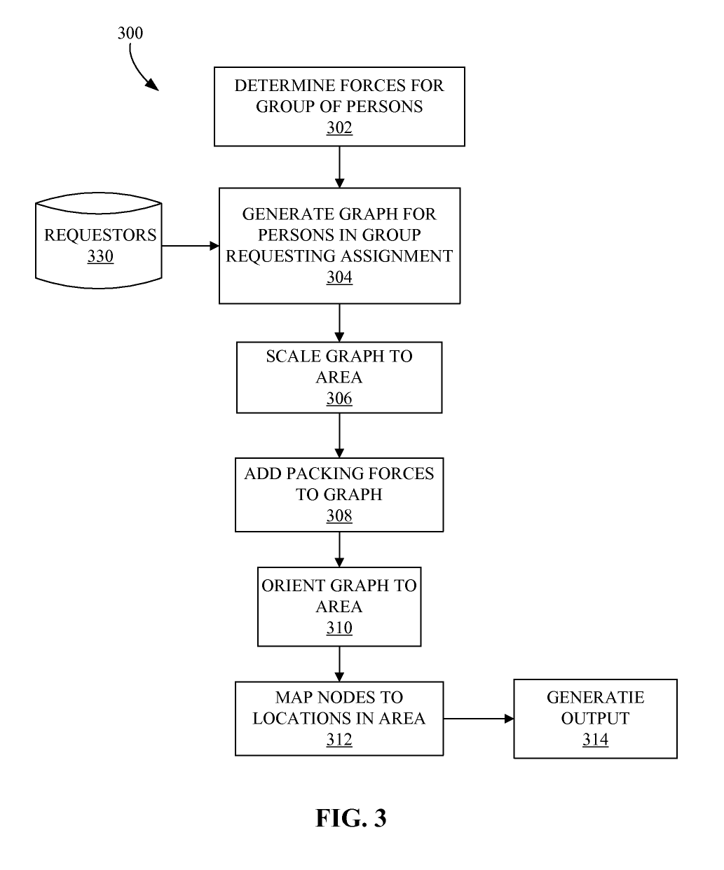

FIG. 3 is a flow diagram of a process 300 for assigning locations in an area according to various embodiments. In operation 302, forces may be determined for every person in a group of persons, e.g., all employees. Forces correspond with weights and weights may be determined from inferences. Forces may be determined for pairs of persons. Specifically, inferences may be based on electronic communications between a person and every other person in the group. Electronic communications may include email, instant messaging, text messages, phone calls, and other similar forms of communication. Systems that provide these electronic communications may be modified to provide the system 100 with data needed to perform any of the various operations required by the embodiments disclosed herein. Operation 302 may include monitoring communications between persons in the group over a specified time period, e.g., two weeks, one month, or three months. A number of electronic communications between a person and other persons in the group may be determined. In some embodiments, fewer than all communications are tracked or counted. For example, communications that relate to personal matters may be excluded. Communications that relate to personal matters may be excluded based on input from a user. For example, a user may review a record of his or her communications and select particular communications to exclude on the basis that the communications were not related to a work activity. In some embodiments, communications that relate to personal matters may be excluded based on an automated analysis of content included in the message. For example, a message may be searched for key words, such as the name of a sports team, a movie or TV show, an actress or performer, a politician, or the like. Messages that include key words not typically included in communications of the organization may be automatically excluded in some embodiments. Alternatively, messages may be searched for key words typically included communications of the organization and messages that do not include at least one of these key words may be automatically excluded in some embodiments. In addition to the number of communications, the recency of particular communications may be determined. It may be inferred that recent communications are more relevant than less recent ones and, therefore, are assigned a higher weight than less recent communications.

In various embodiments, a repulsive force may be placed at each primary node.

According to various embodiments, an “area” may include one or more rooms. When a building includes two or more rooms, the rooms may be connected via a hallway or be on different floors of multi-story building. The area may include a special purpose room, such as hard copy room where printers and copy machines are located, or a conference room. Some organizations may provide badge readers that use RFID or other types of electronic readers at various locations within a building. The badge readers may be placed at various locations in the area, such as at entries to rooms or floors. Each time a person wearing a badge enters a room, uses an elevator, or passes through a hallway, the person passes within range of the electronic reader and the identity of the person, the time, date, and location of the person may be collected. (An electronic reader, such as an RFID reader, may have a range on the order of three feet.) At the end of a data acquisition period, weights may be determined that are proportional to the number of times the person visited the location. Operation 302 may include determining a force between a person and a location, the force corresponding with the weight. For example, a first person may visit a printer room having an RFID badge reader fifty times in a particular week while a second person may only visit the printer room twice during the week. The force between the first person and the printer location may be weighted relatively heavily while the force between the second person and the printer location may be weighted relatively lightly.

In operation 304, a graph may be generated for persons who requested a location assignment. If fewer than all persons in the group request a location assignment, the graph will be generated for a subset of the group. For example, only thirty percent of the group may request to reserve a location on a Friday, the remaining seventy percent electing to work from home. The forces for all persons in the group as determined in operation 302 and a requestor file 330 containing those persons in the group who made a request to reserve a location in the area may be available to a module performing operation 304. The requestor file 330 may be generated using the process 400 described below.

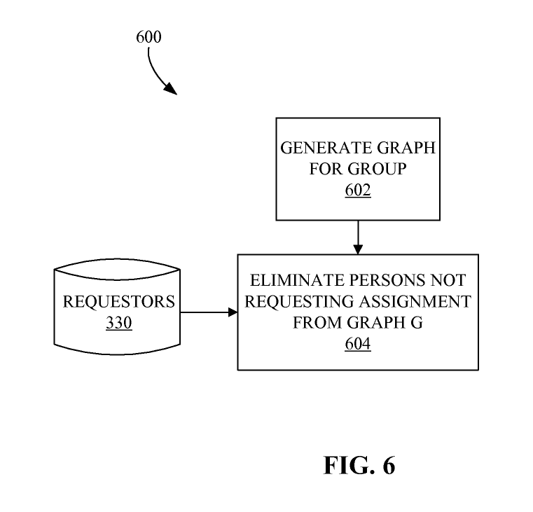

In an alternative embodiment, operation 304 may include generating a graph for all persons in the group. Referring to FIG. 6, in operation 602 of a process 600 for generating a graph, a graph for all persons in a group, e.g., all employees may be generated. In operation 604, persons in the group who did not make a request to reserve a location in the area may be subtracted from the graph. The result is a graph may be generated for persons who requested a location assignment.

According to various embodiments, one or more force-based techniques may be used to generate a graph. Force-based techniques use a physical world analogy. Force-based techniques may analogize two types of forces. An edge between two nodes may act as a spring, resulting in an attractive force between the nodes. A node may have a repulsive force associated with it that may be analogized to a point charge. Attractive forces tend to pull nodes together. Repulsive forces tend to push nodes apart. Both attractive and repulsive forces may have a magnitude. The sum of the attractive and repulsive forces between two nodes determines the distance between the nodes. According to various embodiments, the attractive force between two nodes may be proportional to the number of communications in a particular time period between the two persons. If there are no communications between two persons, there is no attractive force and no edge between them. If there are many communications between the two persons, there will be a strong attractive force and a short edge between them. In force-based techniques, nodes may be distributed in some initial configuration in a two dimensional space. Forces are then applied to form a graph having a shape different from the initial configuration. The resulting shape may depend on the initial configuration in addition to the applied forces.

The graph that is constructed in operation 304 may include defining each requesting person as a primary node. In addition, in various embodiments, objects such as a printer, a window, door, white board, or any other desired object may be specified as a secondary node.

In some embodiments, a force may be applied between particular primary nodes (persons) and secondary nodes (objects), such as badge reader locations. The force between a person and an object may be determined based on data collection (e.g., monitoring of electronic communications or collecting RFID reader data) or on an input by a user. For example, a user may express a moderate or a strong preference to be seated near or away from a node, such as a printer or a conference room, or another person. A user input of a preference may be input via the user interface 110.

In some embodiments, a first person may express a preference for a quiet work space. This preference may be taken into account by increasing the initial repulsive force associated with the node for that person. In addition, if monitoring determines that a second person has large number of telephone communications, it may be inferred that the person is noisier than average. The initial repulsive force associated with the first person may be further increased with respect to the second person in order to reflect the first person's preference for quiet and the second person's propensity for noise.

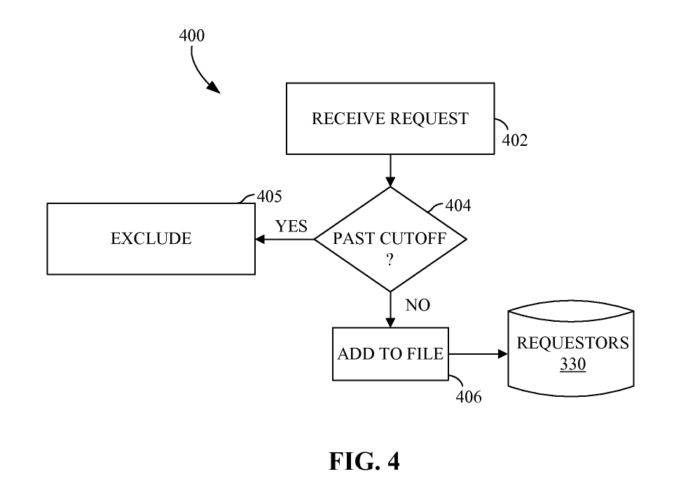

Before describing operations 306-314 of FIG. 3, FIG. 4 is described. FIG. 4 is a flow diagram of a process 400 for receiving reservations or requests for force-based assignments of locations according to various embodiments. In operation 402, a request from a person for an assignment is received. Each request may include the days and times that the requestor wishes to use space in the building. In operation 404, a determination may be made as to whether there are additional requests for seating. For example, there may be a cut-off time to request assignments. If the current time is prior to the cut-off time, additional requests may be accepted. If the current time is after the cut-off time, the request may be excluded from the process 300 (operation 405). In operation 406, a requestor may be added to a file of requestors 330. Each request may be assigned a preliminary location or node in a graph. The requestor may be assigned to a randomly selected node. In one alternative, preliminary nodes may be assigned sequentially and the requestor may be assigned a next node in the sequence.

Referring again to FIG. 3, operation 304 results in a graph of persons who requested a location assignment. Because the graph is force based, primary nodes will generally be at different relative locations than their preliminary locations. In addition, the scale of the graph will generally not correspond to the scale of an area. In operation 306, the force-directed graph may be scaled or normalized to fit the area. In one embodiment, a first distance between the two closest nodes may be compared with a second distance between the two closest locations in the area. A factor for scaling the first distance to the second distance may be determined from the two distances. This scaling factor may then be used to scale the distances between other nodes. The operation 304 may require that the scaled graph fit within the area. If the scaled graph does not fit within the area, the graph may be re-scaled using a different scaling factor.

In operation 308, a minimal attractive force may be applied to particular nodes of the graph. The minimal force may be applied to all primary nodes (persons) or to only those nodes with no force between them. This alternative may serve to prevent undue dispersion of the nodes in some embodiments. In other words, the additional attractive force may be added to pack people more closely, freeing up larger blocks of space where resources may be turned off.

In operation 310, the force-directed graph may be oriented to the area. In some embodiments, a variance metric may be used to orient the force-directed graph to the area. The variance metric may be determined using multiple “layout candidates.” A first node of the graph is placed at a first one of the locations in the area. For every other node of the graph, a nearest location is identified. No two nodes may have the same nearest location. For all of the nodes except the first, the distance between the node and nearest location is determined. For a graph having N nodes, there will be N−1 distances. These N−1 distances may be summed to determine a variance metric. The first node is placed at all possible locations in the area and a variance metric is determined. In one embodiment, the orientation with the smallest variance metric may be selected. In another embodiment, the process in which the first node is placed at all possible locations and a variance metric is determined for each location is repeated for more nodes than only the first node. Again the orientation with the smallest variance metric may be selected. For example, the process described with respect to a first node may be repeated for all nodes in the graph.

In operation 312, each reservation may be assigned to a location in the area using the force-directed graph. Once an orientation is determined in operation 310, each node may be assigned to its nearest location in the area.

In operation 314, output may be generated. The output may include a floor plan showing assignments. The output may be a communication to the reserving person notifying him or her of the assignment. For example, a seating chart may be presented to users upon checking in. The operation 314 may additionally include a communication to a system controlling a resource, the communication notifying the control system that one or more particular locations are not assigned a reservation and a resource associated with the locations may be turned off.

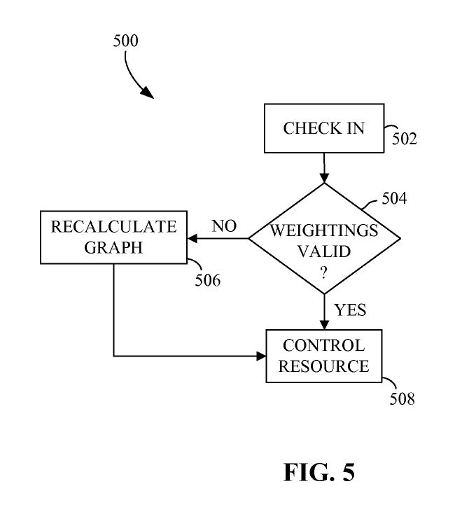

FIG. 5 is a flow diagram of a process 500 for modifying force-based assignments of locations in an area according to various embodiments. The use of electronic communication information to infer relationships between persons may be subject to some false positives and negatives. For example, a person might not talk often to another through electronic media because they often meet in person, or they might talk often but only for personal reasons, not work-related ones. A user may recognize that a communication with another person is assigned an inappropriate weight, e.g., the weighting assignment may have assumed that all communications with a particular person were work related, but one or more of the communications with that person were not work related. The user may modify the weighting and hence the attractive force between him or herself and the person. In one embodiment, a user may modify a weight or a force as part of a check-in process. In operation 502, a user initiates a check-in process, such as upon arrival at the building. The user may be informed of their assigned location. In operation 504, the user interface may display a list of the closest connections taken into account during the allocation process. The user may select persons to remove from the list or include others. The ones that are removed will have their connection weight lowered, and the added ones will have increased weight. In operation 504, the user may determine whether the weightings used in the allocation process are valid. If one or more weightings are modified by the user, the graph may be recalculated in operation 506. In operation 508, location assignment information may be communicated, e.g., by resource controller 122, to various building systems to control resources of the building based on the assignment information. The control may include turning off a resource for a location not assigned a reservation.

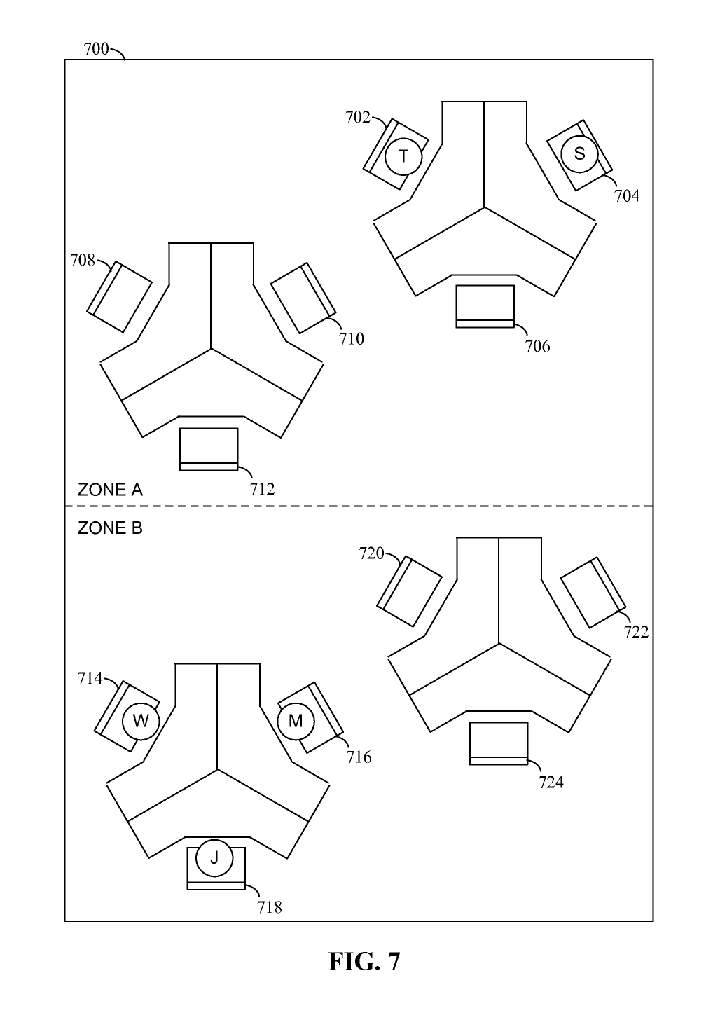

FIG. 7 shows one example of an area 700 having locations 702, 704, 706, 708, 710, 712, 714, 716, 718, 720, 722, and 724. An area may have many more locations than shown in the somewhat simplified example of FIG. 7. The shown area 100 may include two zones: zones A and B. Resources, such as lighting or HVAC may be controlled independently in each zone. FIG. 7 also shows persons T, S, W, M, and J. The persons T, S, W, M, and J are shown at locations in FIG. 7 that they might select themselves. S and his assistant T work in sales. W, M, and J are software developers working together on a project. J and T have a social relationship. J and T make plans for social activities using IM. FIG. 7 shows that persons who work together may tend to sit together and also that persons who do not work together may tend to spread out in an area.

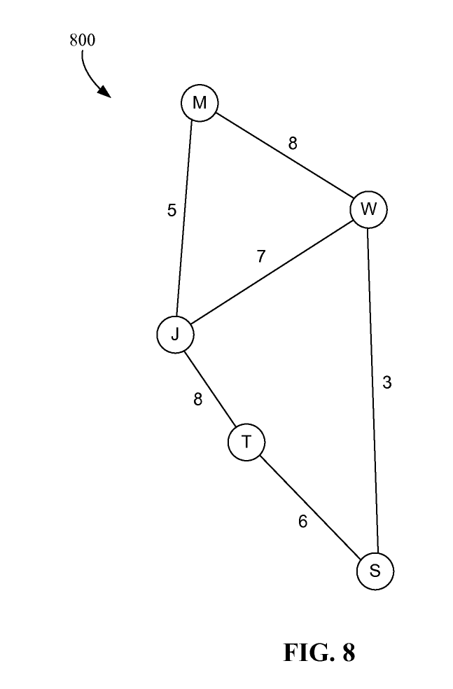

FIG. 8 illustrates an exemplary force-based graph 800 generated from weights as described herein, such as may be inferred from communications between persons. Persons are shown as nodes and weights are shown adjacent to edges between nodes. For example, W had seven electronic communications with J during a particular time period. In addition, W had three electronic communications with S and eight electronic communications with M during the particular time period. In addition, J and T had eight instant messaging communications in the time period.

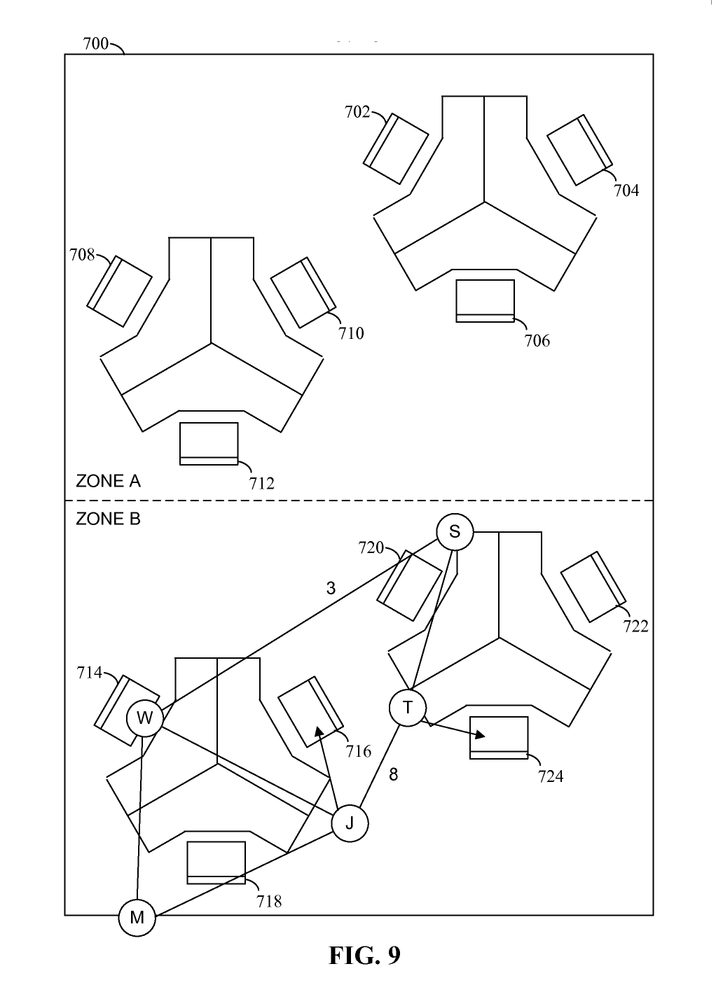

FIG. 9 shows the exemplary graph 800 after the graph has been scaled to the area and after the graph has been oriented to the area 700 in exemplary scaling and orienting operations. In an operation that may be performed subsequent to the scaling and orienting operations, nodes may be mapped to particular locations. Specifically, J may be mapped to location 716 and T may be mapped to location 724. An exemplary weight or attractive force of eight may have been associated with an edge between J and T.

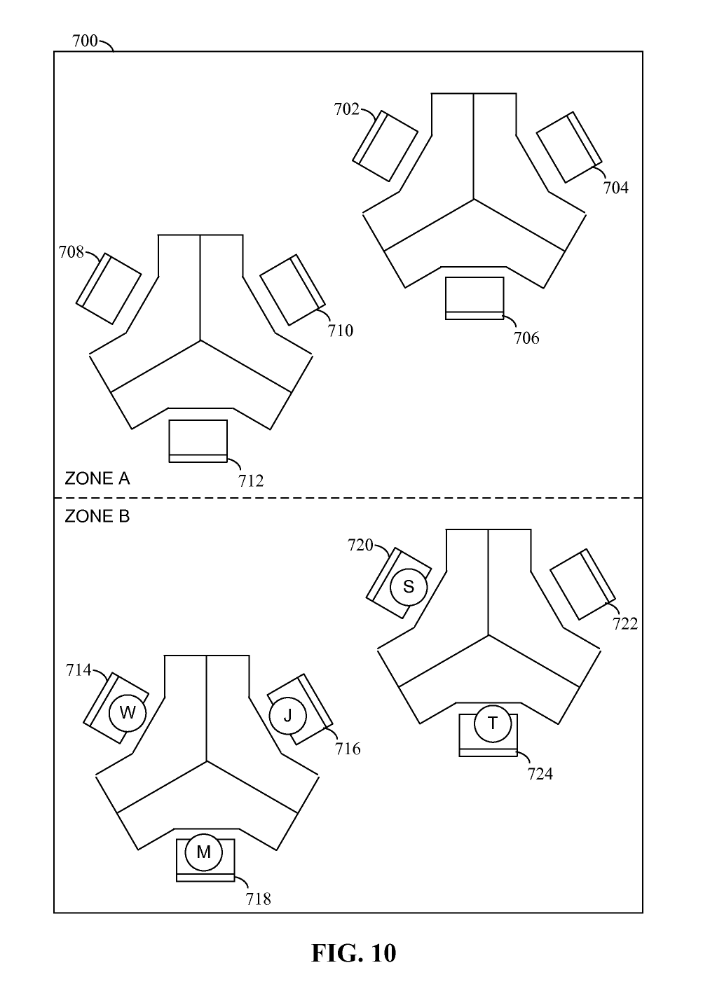

FIG. 10 shows nodes of the exemplary graph 800 after nodes have been mapped to particular locations of the area. In this example, on check in, J learns that an attractive force of eight is associated with an edge between J and T. However, J recognizes that the inference giving rise to the force was based on instant messaging communications of a non-business nature. J instructs the system to disregard the IM electronic communications with T. In response, the system may set the number of communications between J and T to zero and may re-generate the graph 800.

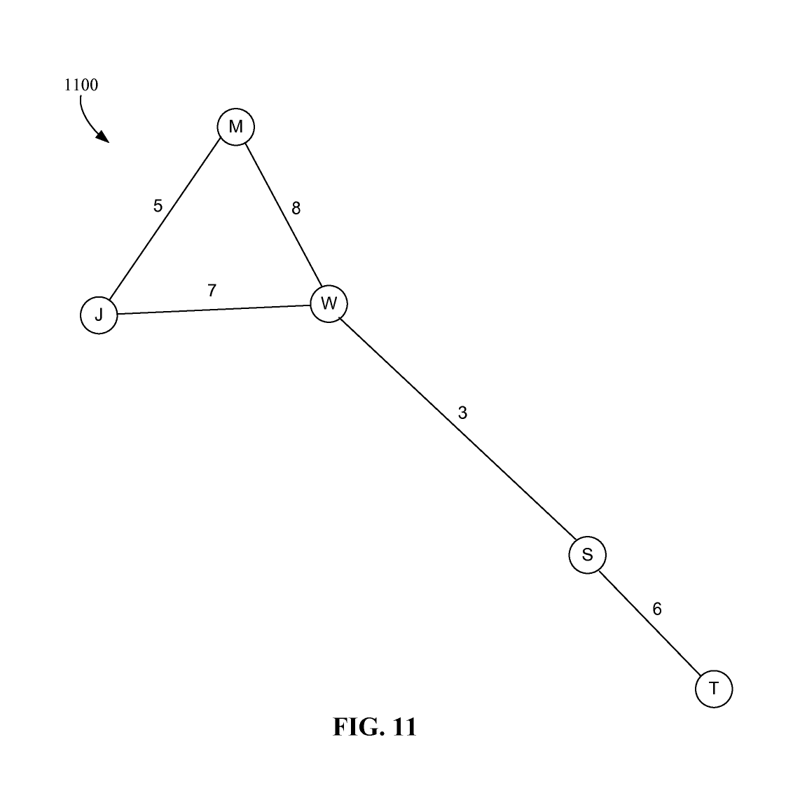

FIG. 11 illustrates an exemplary force-based graph 1100 re-generated from weights inferred from communications between persons after electronic communications between T and J are disregarded. In FIG. 11, it may be seen that the force between W and S is more significant than the revised force between J and T. The only force between T and nodes other than S is repulsive in graph 1100. As shown in FIG. 11, a graph tends to be spread out if forces are not present at all nodes attracting the nodes together.

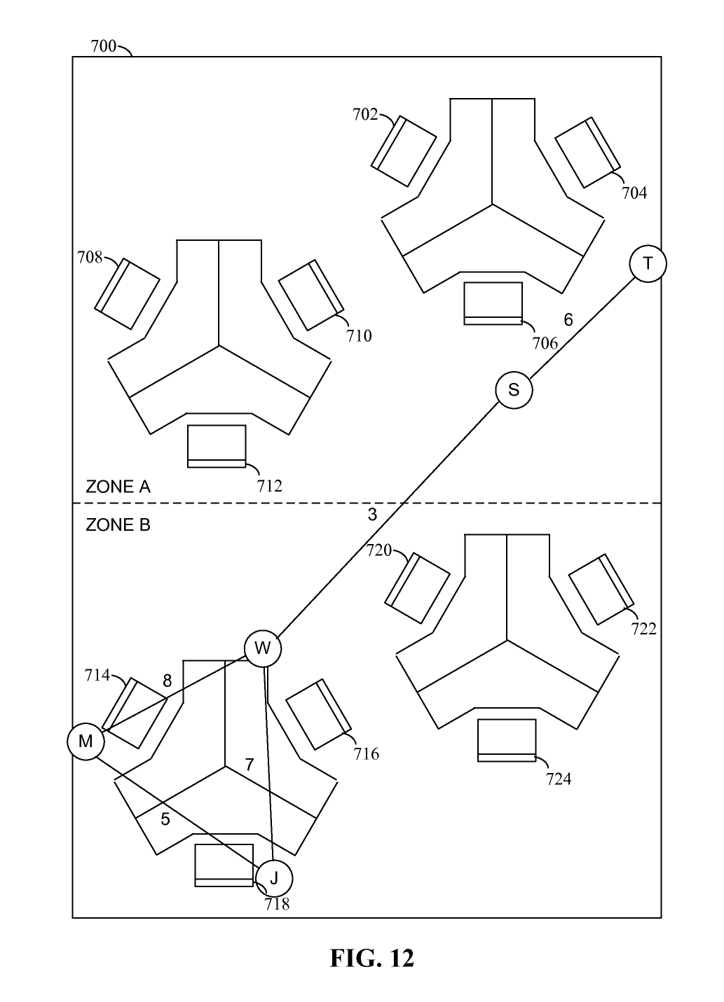

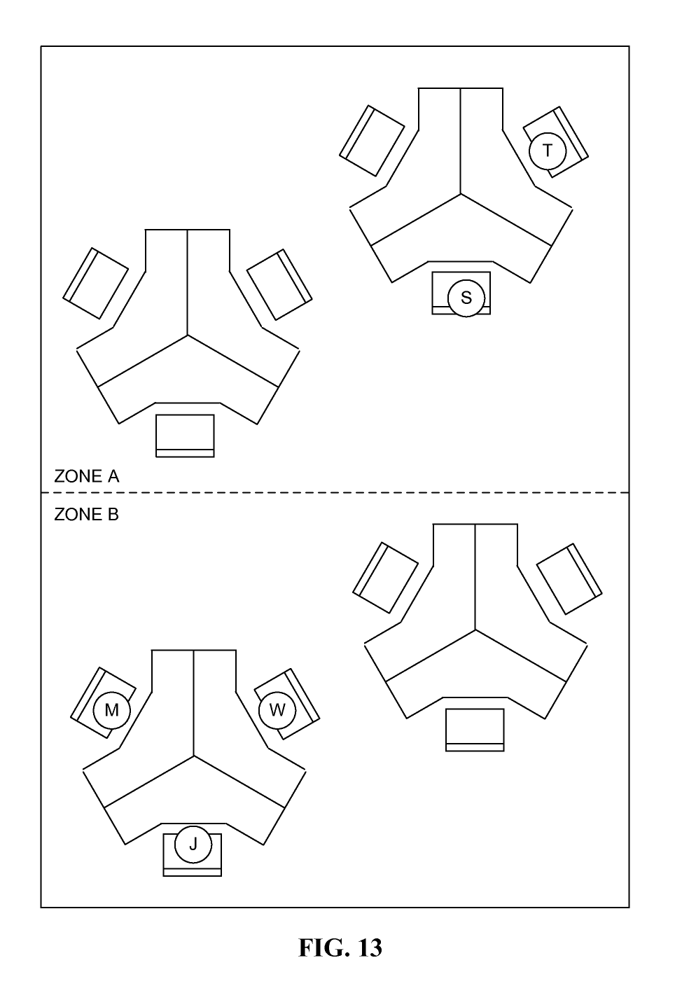

FIG. 12 shows how the spread out graph 1100 might be scaled and oriented to the area. FIG. 13 shows nodes of the exemplary graph 1100 after nodes have been mapped to particular locations.

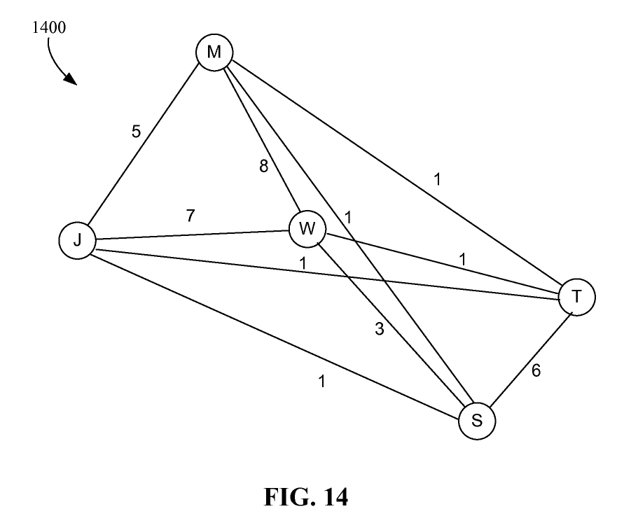

To reduce the spreading out of the graph 1100, a packing force may be added to one or more nodes. The packing force may be significantly weaker than an attractive force, such as one associated with an electronic communication. The packing forces may be added only between nodes that do not have an attractive force as inferred by the system or specified by a user. In FIG. 14, an attractive force of 1 is added to edges between T and M, W, and J. In addition, an attractive force of 1 is added to edges between S and J, and M. These additional attractive forces transform the graph 1100 to the graph 1400 shown in FIG. 14. FIG. 14 illustrates an exemplary force-based graph 1400 re-generated after packing weights have been added.

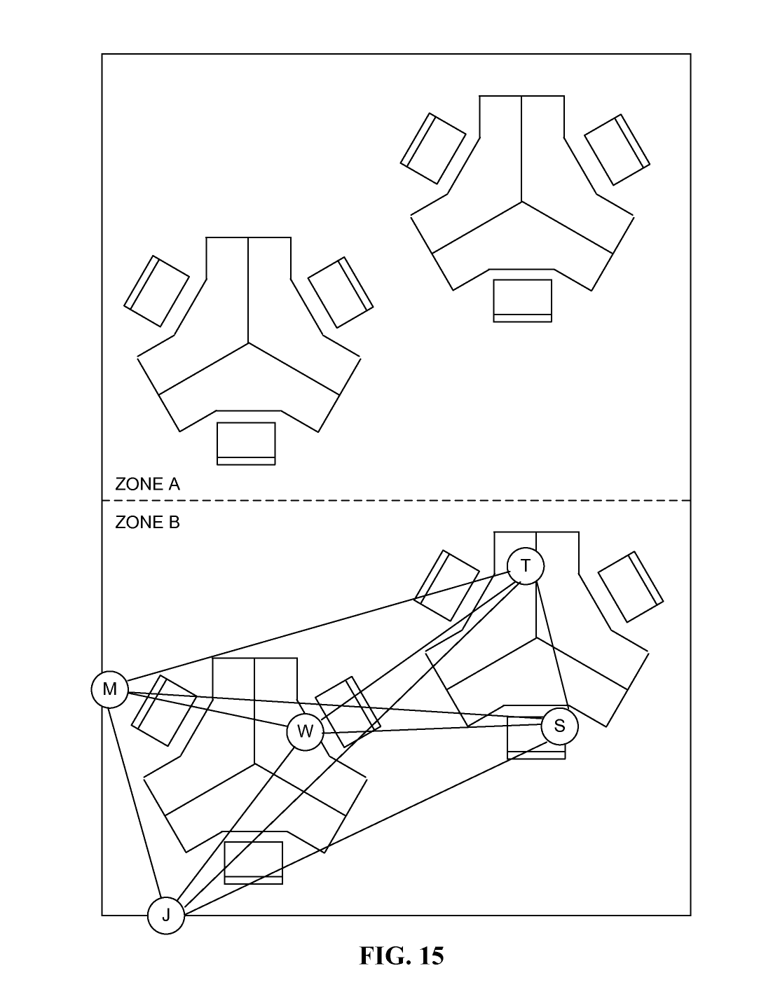

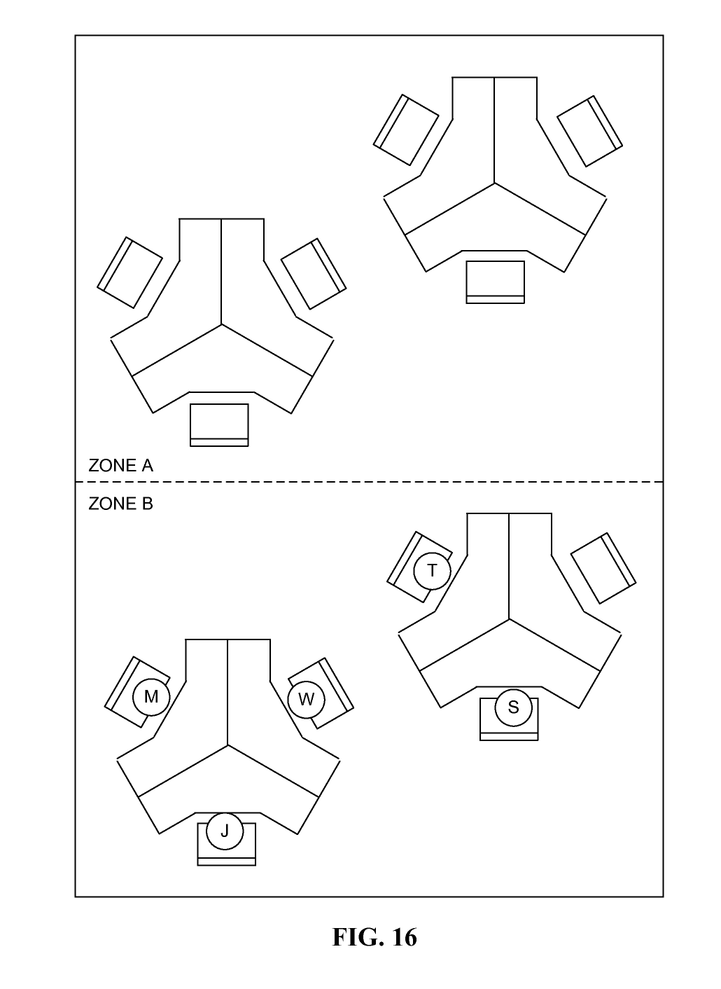

FIG. 15 shows how the graph 1400 scaled and oriented to the area. FIG. 16 shows nodes of the exemplary graph 1400 after nodes have been mapped to particular locations. It may be seen from FIGS. 15 and 16 that packing force act to concentrate nodes in zone B. Concentrating nodes in zone B may permit resources in zone A to be turn off or turned down, which may be an advantage. In addition, M, W and J, who are working together on a common project are assigned locations near one another, and T and S who work together are also assigned locations near each other. Assigning workers having relatively strong forces to locations near one another may be another advantage of embodiments described in this disclosure.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination thereof. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof. In the context of this disclosure, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination thereof.

Computer program code for carrying out operations for aspects of the present disclosure may be written in any combination of one or more programming languages, including: an object oriented programming language such as Java, Smalltalk, C++, or the like; and conventional procedural programming languages, such as the “C” programming language or similar programming languages. The program code may execute as specifically described herein. In addition, the program code may execute entirely on the viewer's computer, partly on the viewer's computer, as a stand-alone software package, partly on the viewer's computer and partly on a remote computer, or entirely on the remote computer or server. In the latter scenario, the remote computer may be connected to the viewer's computer through any type of network, including a local area network (LAN) or a wide area network (WAN), or the connection may be made to an external computer (for example, through the Internet using an Internet Service Provider).

Aspects of the present disclosure have been described with reference to flowchart illustrations, block diagrams, or both, of methods, apparatuses (systems), and computer program products according to embodiments of this disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions or acts specified in the flowchart or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which may include one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

While the foregoing is directed to exemplary embodiments, other and further embodiments of the invention may be devised without departing from the basic scope thereof, and the scope thereof is determined by the claims that follow.

What is claimed is:

1. A computer-implemented method for assigning locations to persons of a group of persons, comprising:
for each person in the group, determining a number of communications between the person and each other person in the group;
receiving a plurality of reservations from reserving persons of the group, each reservation requesting a placement of a reserving person in a location in an area having plural locations;
generating a first force-directed graph having a node for each reserving person, the generating of the force-directed graph including:
establishing an edge between one or more pairs of reserving persons, and
assigning a first weight to the one or more edges that is derived from the number of communications between respective pairs of reserving persons;
assigning each reserving person to a location in the area using the first force-directed graph; and
controlling, based on the assigning of reserving persons to locations, a resource for a location not assigned a reserving person.

2. The method of claim 1, further comprising:
determining that the number of communications between a first pair of reserving persons is zero, and assigning a second weight to an edge between the first pair of reserving persons.

3. The method of claim 1, further comprising:
generating a second force-directed graph in response to receiving a user input to modify one of the first weights; and
assigning each reserving person to a location in the area using the second force-directed graph.

4. The method of claim 1, further comprising:
for each person, determining a number of times the person was within a particular range of an electronic reader; and
wherein the generating of the first force-directed graph includes:
providing a node for the electronic reader,
establishing an edge between the electronic reader and a reserving person determined to be within the particular range of the electronic reader one or more times;
assigning a second weight to the edge between the electronic reader and the reserving person that is proportional to the number of times the reserving person was within the particular range of the electronic reader.

5. The method of claim 1, further comprising scaling the first force-directed graph to the area.

6. The method of claim 1, further comprising orienting the first force-directed graph to the area.
